(19) United States
(12) Patent Application Publication
(10) Pub. No.: US 2008/0291033 A1
(43) Pub. Date: Nov. 27, 2008

(54) System and method for optimization of and analysis of insulated systems

(76) Inventor: Xerxes Aghassipour, Boston, MA (US)

Correspondence Address: SOFER & HAROUN LLP., 317 MADISON AVENUE, SUITE 910, NEW YORK, NY, 10017, US

(21) Appl. No.: 11/899,961

(22) Filed: Sep. 7, 2007

Related U.S. Application Data
(60) Provisional application No. 60/843,517, filed on Sep. 7, 2006.

(51) Int. Cl. G08B 21/00

(52) U.S. Cl. 340/584

(57) ABSTRACT

A method for monitoring environmental conditions within a shipping package includes generating a package shipment route and entering an environmental parameter corresponding to an exposure level beyond which a product, contained in the package, will perish. A wireless data monitor is inserted within the package, configured to monitor the environmental condition within the package along the shipment route, such that during shipment, the environmental data at the wireless data monitor; and during shipment, the collected environmental data is periodically transmitted to one or more wireless access points.

### RELATED APPLICATION

This application claims the benefit of priority from Provisional Patent Application No. 60/843,517, filed on Sep. 7, 2006, the entirety of which is incorporated herein by reference.

### FIELD OF THE INVENTION

The present invention relates to a system and method for a logistics platform for use in optimizing the transport of goods. More specifically, the present invention relates to providing a logistics platform for use in optimizing and monitoring the delivery of perishable goods.

### BACKGROUND OF THE INVENTION

The shipment of perishable goods involves a complicated process of packaging, transportation, and monitoring. A balance must be struck between keeping costs manageable while at the same time maintaining the security and quality of the product being shipped. This process includes many difficult decisions such as determining the optimal type and level of insulated packaging, type and amount refrigerant or warm packs required, among other perishable goods transportation requirements.

Common causes of loss of perishable goods during shipments include, but are not limited to, packing errors, mishandling, regulatory and customs holdups, unseasonably high and low temperatures, flight delays, recipients that are unable to receive delivery, and other unforeseeable difficulties. Services that provide near-perfect service in order to overcome these difficulties are often very expensive. This follows because such services handle their packaging needs based on a worst case scenario and employ container insulation and refrigerants for the worst foreseeable delivery arrangements.

Shipment monitoring is growing in importance for quality control, insurance and regulatory requirements. Monitoring shipments relies on verifying upon every handoff in the supply chain whether or not perishable goods have been shipped within the pre-determined environmental parameters (temperature, humidity, etc). Monitoring the environmental conditions and tracking the location of a perishable shipment seamlessly and efficiently throughout the supply chain aids in the following; making accept/reject decisions at handoffs in the supply chain; ensuring proper performance of temperature controlled transportation and warehousing performance; shipment optimization; dispute resolution; tracking of stolen or mishandled product; determining upon delivery if excursions in a shipment's environmental conditions have negatively impacted product integrity or shelf life.

The current monitoring process typically involves an operator who manually launches and downloads environmental data from electronic data monitors placed within a shipment. This is an expensive, laborious, and time consuming process. Individual packages need to be opened one by one, and a receiver must manually upload the environmental information for each package to ensure quality. Furthermore, the current process does not allow for in-route monitoring of shipments through the supply-chain so that problems can be identified and dealt with prior to product spoilage.

Wireless data monitors have not found wide market adoption to date as they function on proprietary radio frequencies that require costly proprietary reader network infrastructure installed across the whole supply chain.

What is needed is a wireless data monitor that seamlessly integrates into a logistics platform that can leverage existing wireless infrastructure to transmit the environmental conditions and location of shipments throughout manufacturing facilities, warehouses, distribution centers, and transportation vehicles cost efficiently.

In response to the considerable demands placed on global companies to streamline their supply chains, many of the larger corporations have begun employing technology-based solutions, such as shipment tracking and tracing features and recipient e-mail notification. However, most of the platforms currently available are directed to the delivery of common goods and are not readily convertible for use with the transport of perishable goods. As such, a need exists in the field of delivery of perishable goods to provide a service that provides, a complete end to end logistics platform, which optimizes and monitors all of the various steps required in a shipment process.

### SUMMARY OF THE INVENTION

As such, the present invention provides a complete logistics platform which combines optimization technology, packing technology, group aggregation, and monitoring technology in order to extract the maximum value in a perishable goods supply chain.

The optimization technology enables efficiency gains by employing algorithms, which simultaneously evaluate multiple variables. A shipper enters the temperature parameters within which a product temperature must remain during the shipment, origin and destination address of the shipment and the system analyzes all of the possible shipping carrier and shipment options and evaluates the refrigerant quantities needed to maintain the product at the required temperature provided. The systems then gives the shipper the ability to rank and select the possible routes based on cost, delivery date or any other criterion that the shipper wishes to view.

The system also provides the shipper with a choice of feasible packaging arrangements for the desired delivery.

Furthermore, in accordance with another embodiment of the invention, the system is configured to monitor the environmental conditions and location of the product being shipped so as to ensure that its environmental parameters have substantially remained within its specified range, and if not, the system is configured to determine at which point and location during the shipment process the products environmental conditions fell out of or exceeded the specified range.

Shipment monitoring is provided by the use of a wireless data monitor placed within a shipment to monitor the products environmental conditions and/or on the outer surface of a shipment to monitor the shipments ambient environmental conditions.

The wireless data monitor is designed to leverage the existing IEEE 802.11 wireless infrastructure for wireless communication. Leveraging the existing 802.11 wireless infrastructure eliminates the need to build and deploy a proprietary reader infrastructure to monitor perishable shipments around the world. Furthermore, a data monitor that leverages 802.11 wireless capabilities can determine the location of shipments by means of measuring signal strength to known wireless access points along the route using location determining techniques known in the art.

This would enable supply chain constituents to leverage the 802.11 wireless infrastructure deployed throughout their distribution facilities and on their wireless mobile communication devices to monitor the environmental condition and track the location of perishable shipments.

Companies can leverage existing mobile wireless communication devices on transportation vehicles to upload and relay the environmental condition and location of a perishable package in transit to delivery without having to open the package. Thus, the environmental condition of the shipment could be monitored to verify the product has remained within its specified range so that the recipient is ensured that products integrity has not been compromised.

The system is configured to interface with all of the various parties involved in the supply chain of the goods including but not limited to: the shipper, client and their customer service office; the goods receiver; the packaging service provider; the IT service providers; and other 3rd parties such as freight shippers, and the shipper's distribution centers. This cross party logistics platform greatly optimizes the supply chain for perishable goods not only by organizing the supply chain, but also by providing access to all parties involved in the supply chain so that valuable information can be easily shared with all necessary parties.

### BRIEF DESCRIPTION OF THE DRAWINGS

FIG. 1a is a block diagram of a logistics platform in accordance with one embodiment of the present invention;

FIG. 1b is a block diagram of a monitoring platform in accordance with one embodiment of the present invention;

FIG. 2a is a flow chart of the steps involved in operating the system in FIG. 1a and FIG. 1b in accordance with one embodiment of the present invention;

FIG. 2b is a flow chart of the steps involved in operating the system in FIG. 1a and FIG. 1b continued from FIG. 2a in accordance with one embodiment of the present invention;

FIG. 2c is a flow chart of the steps involved in operating the system in FIG. 1a and FIG. 1b continued from FIG. 2b in accordance with one embodiment of the present invention;

FIG. 2d is a flow chart of the steps involved in operating the system in FIG. 1a and FIG. 1b continued from FIG. 2c in accordance with one embodiment of the present invention;

FIG. 2e is a flow chart of the steps involved in operating the system in FIG. 1a and FIG. 1b continued from FIG. 2d in accordance with one embodiment of the present invention;

FIG. 3 is a screen shot of the order entry phase of the recipient's information, in accordance with one embodiment of the present invention;

FIG. 4 is a screen shot of the order entry phase of the delivery constraints, in accordance with one embodiment of the present invention;

FIG. 5 is a screen shot of the company's information stored during the setup phase, in accordance with one embodiment of the present invention;

FIG. 6 is a screen shot of the distribution center's information stored during the setup phase, in accordance with one embodiment of the present invention;

FIG. 7 is a screen shot of the packaging properties stored in the packaging database during the setup phase, in accordance with one embodiment of the present invention;

FIG. 8 is a screen shot of the product properties stored in the product database during the setup phase, in accordance with one embodiment of the present invention;

FIG. 9 is a screen shot of the carrier/mode properties stored in the carrier/mode database during the setup phase, in accordance with one embodiment of the present invention;

FIG. 10 is a screen shot of the shipping solutions, in accordance with one embodiment of the present invention; and

FIG. 11 is an ambient thermal temperature profile, in accordance with one embodiment of the present invention.

### DESCRIPTION OF THE INVENTION

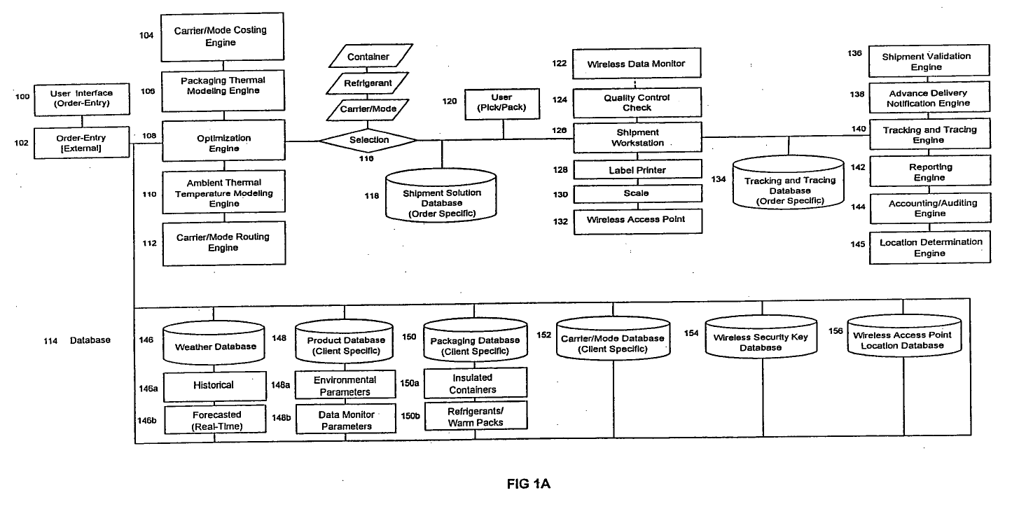

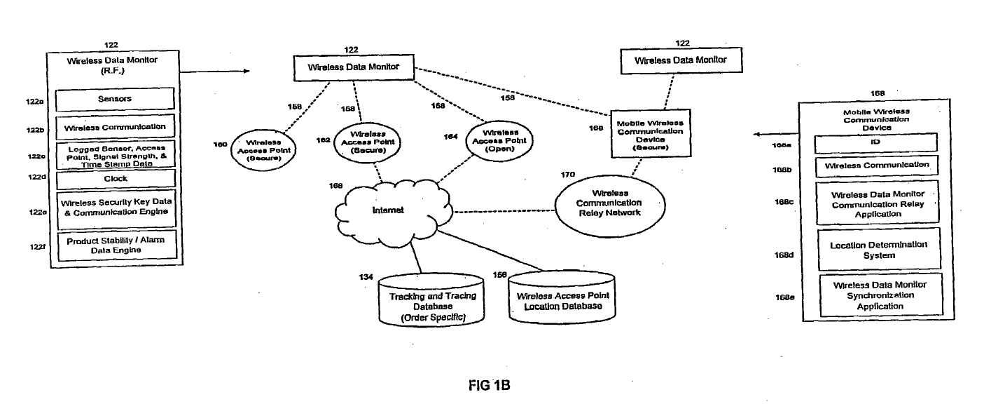

The present invention provides for a logistics platform system 10 having the structure set forth in FIG. 1a and FIG. 1b.

In one embodiment of the present invention, illustrated in FIG. 1a, system 10 comprises a user interface module 100, that allows the user to input the order.

An external order entry module 102 is provided, configured to store a log of the day's orders and then the orders are combined and entered together into system 10. User interface 100 and external order-entry 102 are coupled to an optimization engine 108. Optimization engine 108 receives orders from user interface module 100 and external order entry module 102. Optimization engine 108, coupled to the database 114, retrieves information required for the order.

After retrieving the appropriate information, optimization engine 108 uses the order information to determine the product's origin (distribution center), temperature parameters (the maximum and minimum temperatures that define the temperature range that the product must be maintained within through out the entire shipment), mass (weight of the product), staging temperatures (starting temperature during the packaging process), thermal properties (rate at which the product itself retains or losses heat), and appropriate packaging types (packaging materials and their various heat transfer properties as well as refrigerant or warm packs and their associated ability to maintain constant product temperature within the package), and all possible ways to ship the package (including all of the available carriers, employed by a particular shipper, that deliver to the desired destination and the actual geographic route that the package will traverse using that particular carrier).

Database 114 is configured to store information, which can be accessed by system 10, and used to generate the shipping solutions. (The user specifies information that is stored in database 114.) A weather database 146 stores both historical 146a and forecasted (real-time) 146b weather information. Weather database 146 may receive information from system 10 based on prior shipping results discussed in more detail below. A product database 148 stores the properties of products, such as products origin (distribution center), product thermal properties, mass, staging temperature for the product, required safety buffer if required (additional thermal range required to ensure that a product does not spoil, particularly in the case of extremely temperature sensitive products), environmental parameters 148a (maximum and minimum temperature, humidity, and shock range), products tolerances, and products data monitor parameters 148b time out of range alarm settings, and transmission and recording frequency.

A packaging database 150 stores different types of insulated packages information 150a that can be used, such as styrofoam or reusable containers information as well as the different types of refrigerants/warm pack information 150b that can be used. For each of the package information stored in packaging database 150 outside dimension, inside dimension, weight, cost, and thermal properties (Insulation or R-value inftz Fh/Btu, insulation, thickness) are included. Insulated package and refrigerant/warm pack information 150a and 150b are client specific, based on the various client uses. A carrier/mode database 152 stores information such as what carriers the client uses and the modes of shipment, such as overnight 2nd day or 3rd day ground, which those carriers offer, including the actual geographic routes which are traveled over in those modes.

The wireless security key database 154 stores the wireless access security keys and passwords required for the wireless data monitor 122 to gain access to and transmit data through wireless access points and mobile wireless communication devices of supply chain constituents including but not limited to transportation providers, distributors, wholesalers, and recipients. These security keys and passwords are specific to individual providers and supply chain constituents and are typically changed frequently for security purposes.

The wireless access point location database 156 stores the geographic location (longitude and latitude of a unique wireless access point. It is used by the location determination engine 145 to compute the location of a shipment as it travels through the supply chain in a process known in the art.

Database 114 can be updated either through the user inputting data, shipping information provided over the internet, or data installation, such as CD ROM provided by the carriers at the location of the database. Updates can also be based on feed back information from the system itself, a process described in more detail below.

It should be noted that weather database 146, product database 148, package database 150, carrier/mode database 152, wireless security key database 154, and wireless access point location database 156 are all in database 114 and can share information and are accessible to system 10. Database 114 and its component databases can exist as either a single database or as a conglomeration of several databases as illustrated. These examples of databases for storing information are intended only as examples of possible types of databases and information used and are in no way intended to limit the scope of the present invention. Any similar database used for operation within a similar system is within the contemplation of the present invention.

A carrier/mode routing engine 112 is coupled to optimization engine 108 and configured to determine all of the possible routes that the product might be shipped over. Depending on how the package will be shipped, carrier/mode routing engine 112 determines what states, city, or zip codes the package will be routed through so as to allow retrieval of the weather forecast for the intended route. The possible routes that can be used are provided by the carrier/mode routing engine 112 and delivered to an ambient thermal temperature modeling engine 110.

For example, in operation carrier/mode routing engine 112, using carrier/mode database 152, determines a route for each carrier such as USPS, UPS, FedEx, DHL and each of their modes of delivery such as 2nd day air, ground, next day am, and next day pm. This model information includes the specific cities traveled through and transportation mode used such as plane, train or motor vehicle.

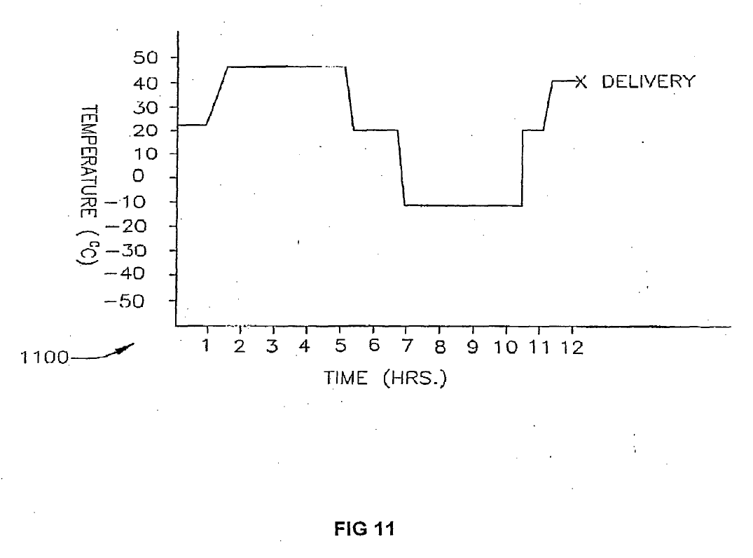

Ambient thermal temperature modeling engine 110 is configured to receive the carrier route information from carrier/mode route engine 112 and generate a temperature profile 1100, as illustrated in FIG. 11, for each of the possible routes based on predetermined temperature metrics or historical temperature data stored in weather database 146. Temperature profile 1100 may correlate to a particular shipment's seasonal and geographical route or it may be based on actual real-time forecasted data in correlation to a particular shipment's geographic routing.

For example, profile 1100 may relate to a shipment originating in Binghamton, N.Y. to Miami. Profile 1100 first portion represents the situation where the package is placed in truck during summer season for a four hour drive from Binghamton to Queens. During this time the air temperature in the truck may spike +20° C. The package is then loaded on a plane and is flown for 3½ hours to Miami where, air temperature surrounding the package drops −30° C. while on plane. The package is then loaded on to a truck, and is driven 40 minutes to its destination, where the temperature again spikes +25° C. Profile 1100 created mimics the temperature conditions that the package will encounter in each of the possible carrier/model scenarios profiled. The profile contains temperatures and the duration that the package will endure during its trip. At first, profile 1100 may be defined based on the worst case scenario weather data.

However, through feedback, the system optimizes the weather profile to what is more closely experienced by the package as weather database 146 is populated by saved temperature information from recent past shipments.

A packaging thermal modeling engine 106, is coupled to optimization engine 108. Engine 106 uses profile 1100 from the possible routes generated by ambient thermal temperature modeling engine 110 and calculates the temperature inside the package during the entire route. Packaging thermal modeling engine 106 subsequently generates a thermal model so as to evaluate how much refrigerant/warm packs are necessary to maintain the package within the specified parameters. Packaging thermal modeling engine 106 calculates how long the desired temperature can be maintained inside the package, taking into account the mass of the product, the mass of the refrigerant/heat packs, the thermal properties of the product, packaging or refrigerant/warn packs, the product temperature parameters, and the carrier/mode profiles generated by carrier/mode routing engine 112.

Packaging thermal modeling engine 106 utilizes basic heat transfer principles such as those found in Fundamentals of Heat Transfer, by David P.

Dewitt and Frank P. Incropera, copyrighted 1981, the entirety of which is incorporated herein by reference. For example, using heat transfer principles, packaging thermal modeling engine 106 determines that for a particular profile 1 100 the product that is packaged in a Styrofoam package requires 4 pounds of dry ice, or, the same product is packaged in a plastic package requires 10 pounds of dry ice in order to maintain its specified temperature parameter. This process is repeated for each packaging alternatives based on its ambient thermal profile.

A carrier/mode costing engine 104 coupled to optimization engine, calculates the cost to ship each package according to all the feasible shipping options wherein the specified temperature parameters of the package can be maintained within its specified range. In determining the shipment cost, engine 104 takes several variables into account, such as, the weight and volume of the package, the carrier and the mode of shipment, the insurance amount for shipment, the value of the package, whether it is COD (cash on delivery), whether it is hazardous material, and whether a signature is required for receipt.

Carrier/mode costing engine 104 then outputs the shipping cost for all feasible carrier modes of delivery. For example, the weight of package plus additional weight of refrigerant/warm pack calculated by packaging thermal modeling engine 106 is used to calculate the cost to ship via each of the determined carrier/modes from carrier/mode routing engine such as next day air, or ground. Additionally, any extras such as COD or insurance are added into the cost.

Optimization engine 108 consolidates all the feasible results and forwards them to selection module 116. It is noted that either separate modules or a single optimization engine with all the components contained in it can perform functions as illustrated. The modules used by the optimization engine 108 are only an example of a type of optimization engine that can be used and are in no way intended to limit the scope of the present invention. Any similar optimization engine i8n software or hardware format used in a similar system is within the contemplation of the present invention.

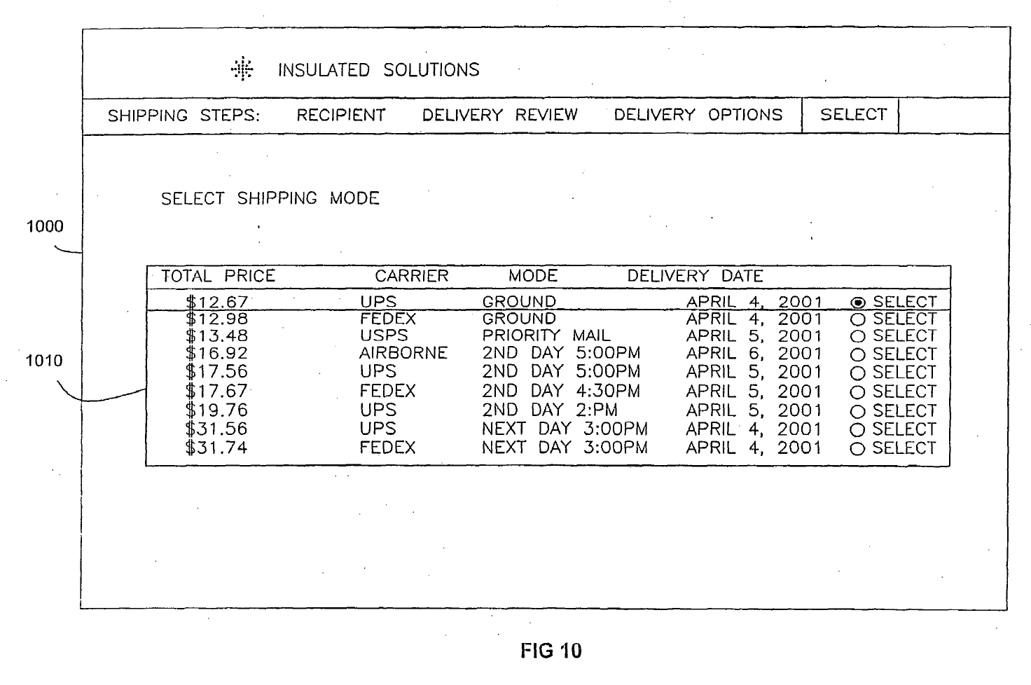

In response to a user selecting a feasible shipping option, selection module 116 provides the relevant shipment details such as the container that is required for the selected shipment route and the amount and type of refrigerant or heat for the selected shipment route. An example of a display that allows shipment selection is illustrated in FIG. 10, wherein a shipment selection page 1000 with shipment selection box 1010 is shown.

In addition to storing selections made at selection module 116, shipment solution database 118 can store solutions that allow the system to automatically make the selection. Shipment solution database 118 can be set so that it automatically picks a shipping solution based on a desired criteria set by the user such as the cheapest solution, cost efficient, fastest solution, worst case scenario, or by deadline for shipment. After selection of a shipment solution, the user is prompted with packaging instructions at a user (pick/pack) module 120.

During packaging, a wireless data monitor 122 can be placed within a shipment to monitor the products environmental conditions and/or on the outer surface of a shipment to monitor the shipments ambient environmental conditions. The wireless data monitor 122 is associated with the shipment via its unique identification number and saved in the tracking and tracing database 134. Tracking and tracing database 134 is configured to receive and store the logged environmental conditions recorded on the wireless data monitor 122 during transit.

After the package is packed it is sent to a shipment workstation 126. Shipment workstation 126 is configured to receive the selected shipment solution and an order number is scanned into shipment workstation 126.

The package is placed on a scale 130. Scale 130 is coupled to shipment workstation 126 and quality control check module 124. The weight output by scale 130 is used by quality control check 124 to check to make sure that the product, refrigerant/warm packs, and the packaging add up to the correct weight that was previously calculated and stored. Label printer 128, is coupled to shipment workstation 126, and prints the label for the completed order. The order number is input and stored in a tracking and tracing database 134, coupled to shipment workstation 126.

The wireless data monitor 122 is used to log a shipment's environmental conditions (temperature, humidity, shock etc.) through transit in a process described below.

Wireless data monitor 122 records environmental conditions periodically and uses an internal clock 122d to time stamp the recorded information 122c. Wireless data monitor 122 is configured to receive and store the environmental parameters for the package that specifies the range within which the product must remain 122f. As such, wireless data monitor 122 functions as an indicator should the package go outside the environmental parameters downloaded for the product contained in the package.

In one embodiment of the present invention an indicator such as red light, located on wireless data monitor 122 indicates that the environmental conditions have gone outside the set parameter. For example, product has temperature parameter of 2° C. to 8° C. and during transit the temperature rises to 15° C., the wireless data monitor 122 illuminates an alarm indicator, such that upon delivery the recipient who opens the package will immediately know of a possible problem. Wireless data monitor 122 sends an alert notification when transmitting data back to the tracking and tracing database 134.

In a preferred embodiment of the present invention the wireless data monitor 122 uses the IEEE 802.11 standard for wireless communication 122b. This allows the wireless data monitor to send and receive data over existing 802.11 wireless local area networks (WLAN's) via wireless access points 132 operating on the 802.11 standard. This eliminates the need to for installing proprietary wireless communication infrastructure reducing deployment costs.

The wireless access point 132 transmits to the wireless data monitor 122 the shipments environmental parameters 148a, data monitor parameters 148b, and wireless security key data 154 necessary to gain access to secure wireless access points 162 and mobile wireless communication devices 168 along the shipment route.

For example if a shipment is going to be shipped via United Parcel Service (UPS) then the wireless security keys necessary to access UPS's wireless access points within its facilities and communicate with UPS's mobile wireless communication device would be loaded onto the wireless data monitor 122 so that communication could take place as the shipment travels though UPS's supply chain.

Wireless access point 132 sends a signal to wireless data monitor 122 to begin the continuous recording of environmental conditions and unique wireless access points and their associated signal strengths in its vicinity.

The wireless data monitor 122 determines if the wireless access points 160, 162, 164 and/or mobile wireless communication device 168 in its vicinity require security authentication to transmit data through and if so it finds out if it has the necessary security key data to gain access. Upon successfully gaining access to an open or secure wireless access point 162, 164 or mobile communication device 168 the wireless data monitor 122 transmits the shipments recorded environmental conditions and logged unique wireless access points and signal strengths 122c recorded along the shipment route to tracking and trace database 134 via the internet 166. The wireless data monitor 122 awaits confirmation that the data sent to the tracking and tracing database 166 has been successfully received. If no confirmation is received the wireless data monitor 122 will continue to attempt to resend the recorded data. This two-way communication capability's allows for optimal memory usage, automatic reconfiguration of wireless data monitors alarm and recording parameters and updating of wireless data monitor 122 software.

Mobile wireless communication device's 168 are typically used by delivery personnel on transportation vehicles, such as United Parcel Service's ‘Delivery Information Acquisition Device’ or DIAD, Federal Express's ‘PowerPad’, and Terion's ‘FleetView’®, to facilitate communication, delivery routing, pickup scheduling, collection and transmission of proof of delivery signatures, and tracking of transportation vehicles.

In a preferred embodiment of the invention, the mobile wireless communication device 168 is capable to communicate via the IEEE 802.11 standard for wireless communication 168b. This allows the wireless data monitor to send and receive data over existing 802.11 wireless local area networks (WLAN's) via wireless access points when configured in infrastructure mode or communicate with other devices operating on the 802.11 standard when in ad-hoc mode.

Wireless communication between wireless data monitor 122 and mobile wireless communication device 168 would be facilitated and made possible by running a wireless data monitor synchronization application 168e on the mobile wireless communication device 168. This wireless data monitor synchronization application 168e would automatically switch and configure the mobile wireless communication device's 168 802.11 wireless communication protocol between ad-hoc and infrastructure modes. In ad-hoc mode the mobile wireless communication device 168 can communicate directly with the wireless data monitor 122 without a wireless access point being present. Wireless access points are not typically found in transportation vehicles. Furthermore it would synchronize the two devices so that both operate on the same service set identifier (SSID) and channel number to facilitate communication. The wireless data monitor synchronization application 168e could then switch the mobile wireless communication device 168 back to infrastructure mode so that it communicates via a wireless access point on a wireless local area network (WLAN) when in a facility to upload and/or receive data.

For example, a mobile wireless communication device such as UPS's DIAD can be in infrastructure mode while it's in UPS's distribution facility overnight in its docking station charging its batteries. While in the facility it can load the next day's delivery locations over the facilities WLAN via a wireless access point. When the DIAD is picked up off its docking station by the UPS delivery driver in the morning the wireless data monitor synchronization application 168e can switch the 802.11 communication protocol to ad-hoc mode. This allows wireless data monitors 122 aboard the vehicle to communicate with the DIAD. A wireless data monitor's environmental condition and recorded wireless access points and their associated signal strengths can be transmitted to and be saved on the DIAD. The wireless data monitor synchronization application can switch the 802.11 communication protocol back to infrastructure mode upon returning to the UPS facility and the saved environmental data can be uploaded via a wireless access point through a WLAN to database for analysis and validation purposes. Alternatively a wireless data monitor's environmental condition can be relayed via the DIAD's cellular communication capabilities while in transit to a database on the internet for real time monitoring and analysis in a process that's described in more detail below.

The wireless data monitor communication relay application 168c can leverage a mobile wireless communication device's 168b additional wireless capabilities, such as a cellular (GPRS/CDMA) wireless communication relay network 170 to transmit the wireless data monitor's 122's recorded environmental and location information via the internet 166 to the tracking and tracing database 134 while in transit. This is significant as it allows real time monitoring of shipments in transportation vehicles. Furthermore this allows real time communication in areas where there are no wireless access points in the vicinity.

In addition to monitoring and storing environmental conditions the wireless data monitor 122 periodically listens for and records the unique identification number, typically the devices media access control (MAC) address, and associated signal strength 158 to wireless access points 160, 162, 164 along the shipment route. The wireless data monitor 122 uses an internal clock 122d to time stamp 122c the recorded information. This information can be used to compute the shipment's location via the location determination engine 145 in a process known in the art and described in more detail below.

The location determination engine 145 can compute the location of shipments by running location determination algorithms known in the art such as time delay of arrival (TDOA) and received signal strength indicators (RSSI) by leveraging a database of known wireless access point's locations in the wireless access point location database 156. Determining the current and historical location of shipments has many benefits to participants including but not limited to, just in time delivery synchronization, optimization of future shipments routing and ambient environmental conditions, dispute resolution, and tracking of stolen or mishandled product.

An up to date database of wireless access point locations 156 along each shipment route is imperative for the location determination engine to locate shipments efficiently. This is especially challenging as wireless access points can be moved, removed, and/or new ones added. In one embodiment of this invention the wireless data monitor 122 and/or mobile wireless communication device 168 can update and automatically self map wireless access point locations along said shipment route and shipping lanes.

The continuous updating and self-mapping of wireless access points along each shipment route is achieved by leveraging a location determination system such as a global positioning system (GPS) or other means of determining a known geographical position in combination with a recorded wireless access point and its associated signal strength 158 from the known location logged along the shipment route. As a wireless data monitor 122 is traveling on a shipping route it continuously listens for and records unique wireless access points and their associated signal strengths, it can be simultaneously can query a mobile wireless communication device's 168 location determination system 168d to determine and log a known geographical position (longitude and latitude). By using location determining engine 145 using algorithms known in the art such as triangulation a wireless access point's location can be computed and updated in the wireless access point location database 156.

In one embodiment of the invention, a wireless data monitor 122 is placed inside a transportation vehicle to monitor a transportation vehicle's environmental conditions. Linking the environmental conditions recorded in a transportation vehicle to the shipments being transported in that vehicle is a complex undertaking as shipments often travel via numerous vehicles, distribution centers, and warehouses from origin to destination. By querying the tracking and tracing database 134 the system can match the unique wireless access points recorded and time stamped on a wireless data monitor 122 placed within the vehicle to the unique wireless access points recorded and time stamped on a wireless data monitor 122 placed within a shipment. Thus, a transportation vehicle's environmental conditions can be linked to shipments that have traveled on them so that the shipments ambient environmental conditions can be analyzed for validation, quality control, and optimization purposes.

In one embodiment of the present invention, as illustrated in FIG. 1a-1b, the package delivered through system 10 can be evaluated and audited. A shipment validation engine 136, advanced delivery notification engine 138, tracking and tracing engine 140, reporting engine 142 and an accounting and auditing engine 144 are utilized by system 10 to evaluate the delivery process. Shipment validation engine 136, which may be located at the shipment recipient's location, validates that the shipped product stayed within the environmental parameters specified by shipper. Shipment validating engine 136 gives a report in any number of forms such as a print out, or on a computer screen.

Reporting engine 142 is coupled to the database 114 of system 10 and evaluates the performance and reliability of the optimization engine 108.

Furthermore, reporting engine 142 provides the actual temperature readings recorded by wireless data monitor 122 to weather database 146, so as to update the historical database 146a for use in perfecting the creation of future temperature profiles 1100.

Shipment validation engine receives the environmental data recorded on the wireless data monitor 122. In the event that shipment validating engine 136 reports that a product left the desired environmental range, accounting and auditing engine 144 determines where during the transit, the environmental conditions left the specified parameter.

This information can then be used to enforce carrier guarantees through credits.

Advanced delivery notification engine 138 outputs some form of notification such as an e-mail, text message, or automated phone call to notify the recipient that the shipment has been sent. Tracking and tracing database 140 is configured to receive information on the location of the package during transit so that the shipper or receiver can then check where the package is.

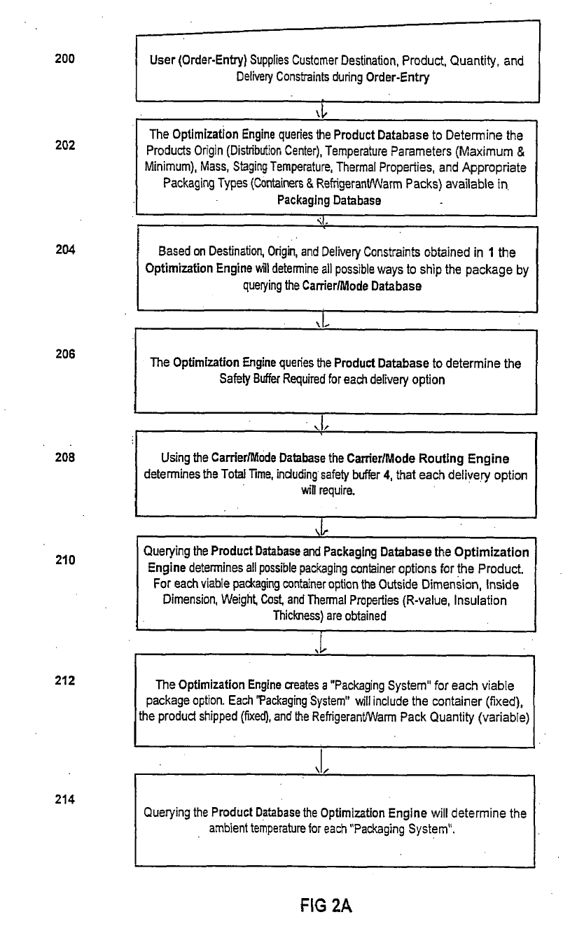

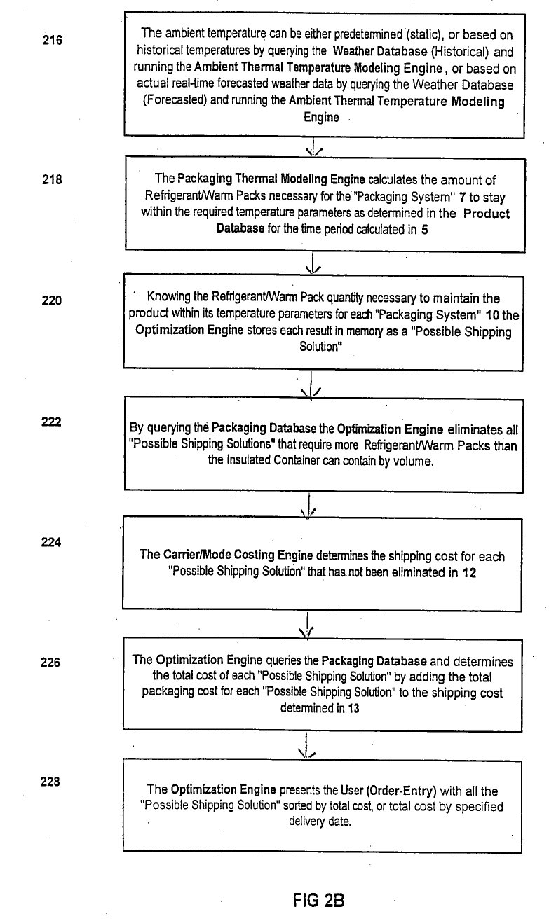

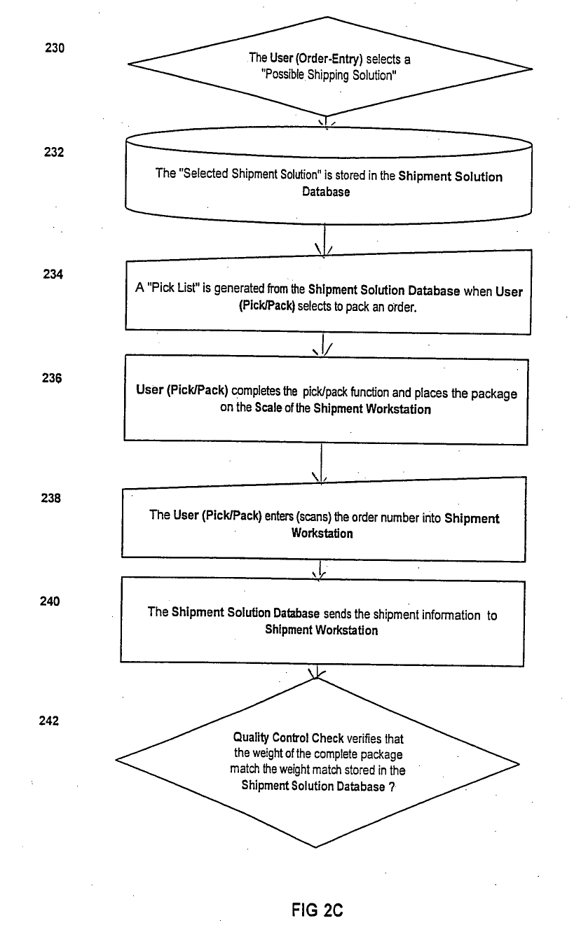

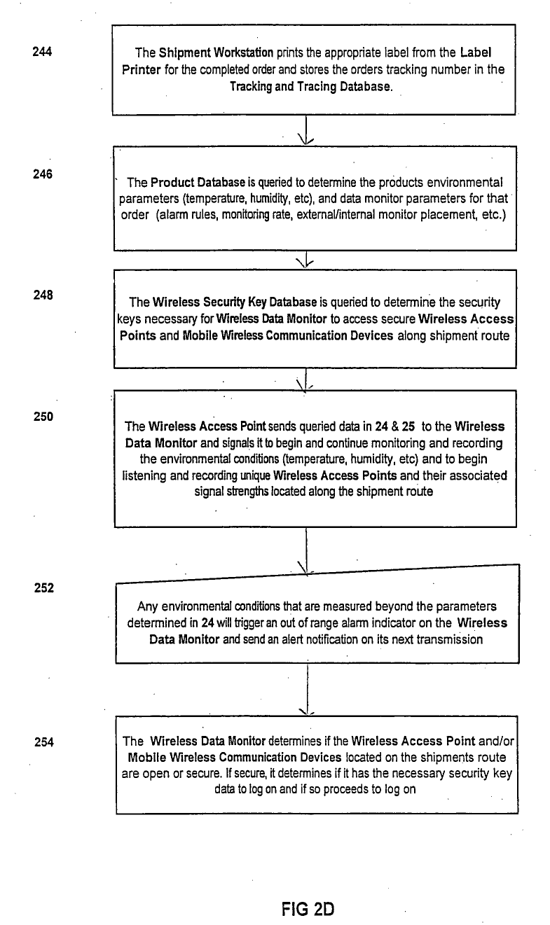

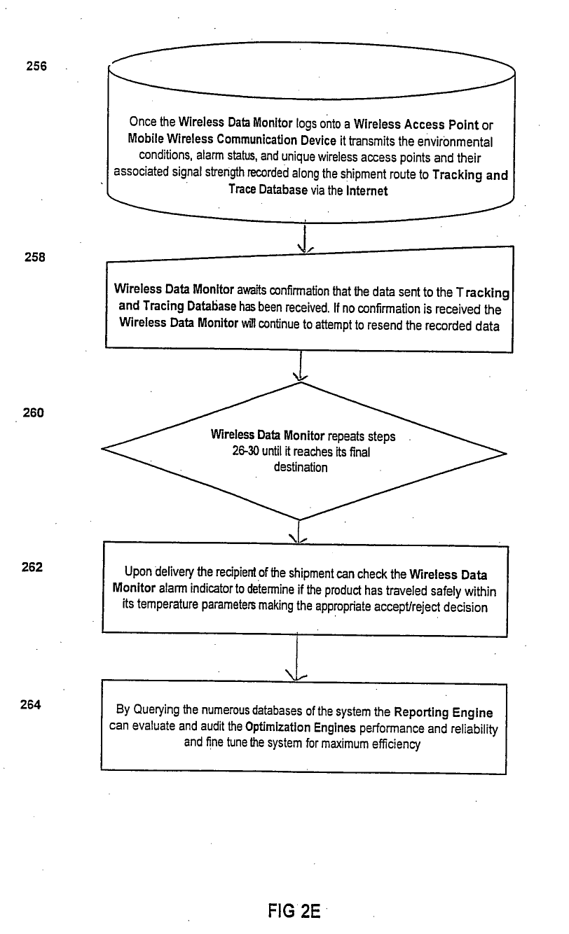

In one embodiment of the present invention, as illustrated in FIGS. 2a-2e system 10 operates in the following manner.

First, at step 200 the user enters specifications into system 10 at order entry modules 100 or 102 such as customer destination, product, quantity, and delivery constraint information. Next at step 202, optimization engine 108 queries the product database 148 to determine the products properties such as origin (distribution center), temperature parameters (maximum & minimum), mass, staging temperature, thermal properties, and appropriate packaging types (containers & refrigerant/warm packs) available in the packaging database 150.

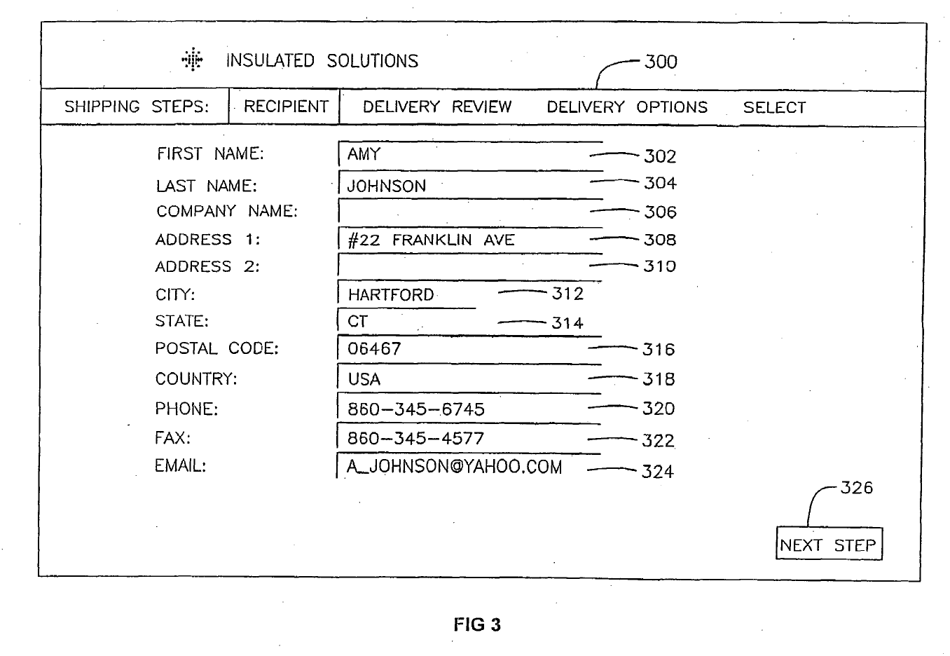

As illustrated in FIG. 3 is a screen shot of an order entry phase. Menu 300 shows the user's step in the order entry phase. The display includes boxes for recipient first name 302, last name 304, company name 306, address “1” 308, address “2” 310, city 312, state 314, postal code 316, country 318, phone, 320, fax 322, email 324, and a button next step 326.

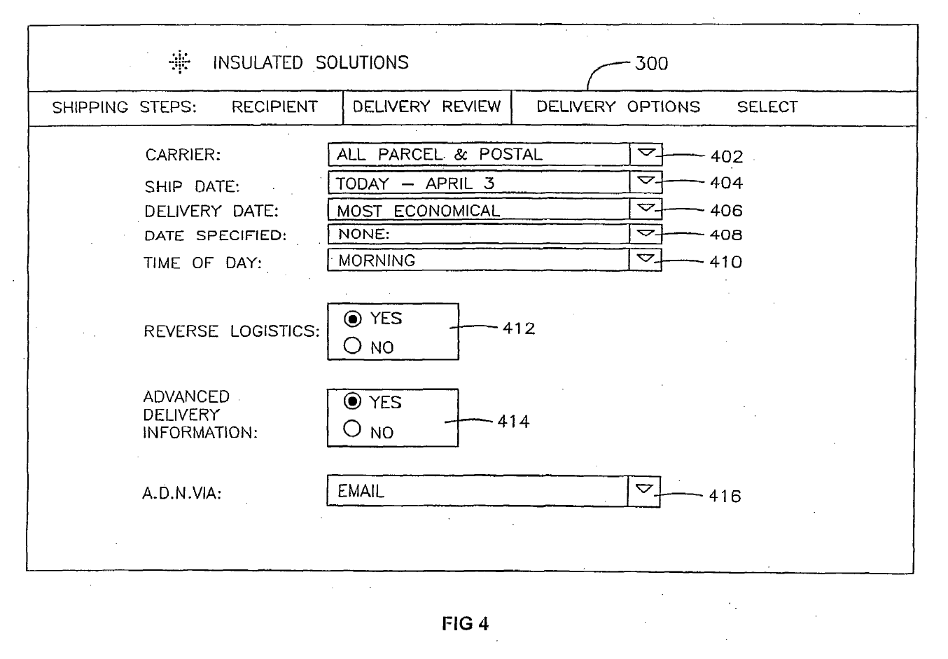

FIG. 4 is a screen shot of the delivery constraints in the order entry phase.

The display includes a menu 300, a pull down selection for carrier 402, ship date 404, delivery date 406, date specified 408, time of day 410 advanced delivery notice via 416, and a box to select reverse logistics 412, and advanced delivery notification 414. Reverse logistics refers to election to use reusable containers so as to save money on future shipments.

Based on the destination, origin, and delivery constraints obtained, the optimization engine 108 determines all of the ways to ship the package by querying the carrier/mode database 153, at step 204. In one embodiment of the present invention, packaging database 150, product databases 148, and carrier/mode database 152 are configured so that the user can input the properties of the packages, products, the location of the company, location of distribution centers and the carrier/modes.

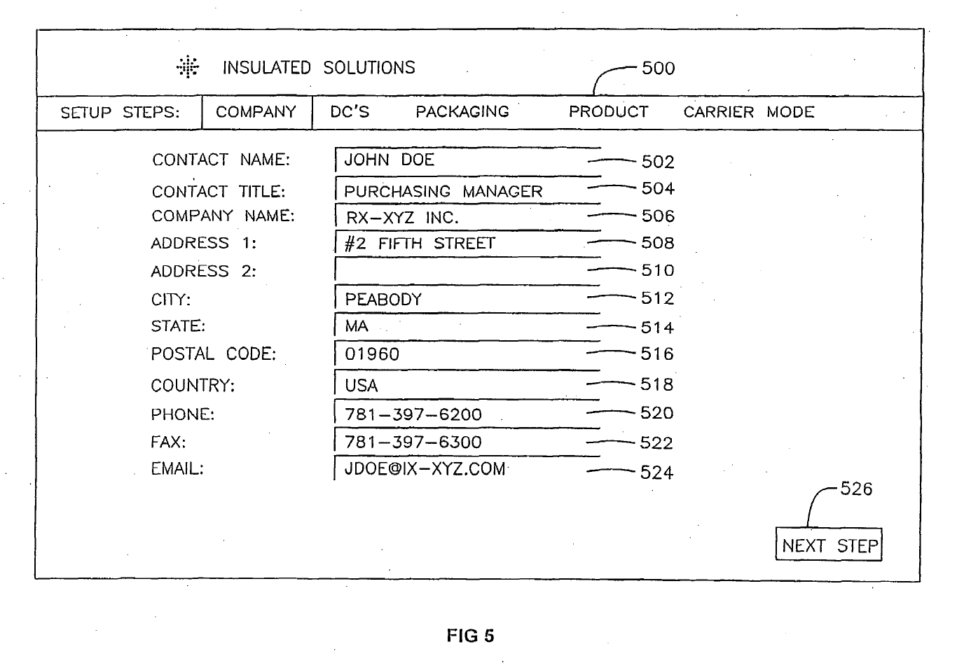

FIG. 5 illustrates a set up phase window wherein the company information is entered into database 114. The display includes a menu 500, a contact name box 502, contact title box 504, company name box 506, address “1” box 508, address “2” box 510, city box 512, state box 514, postal code box 516, country box 518, phone number box 520, fax number box 522, and email box 524, and a button 526 for activating the next step.

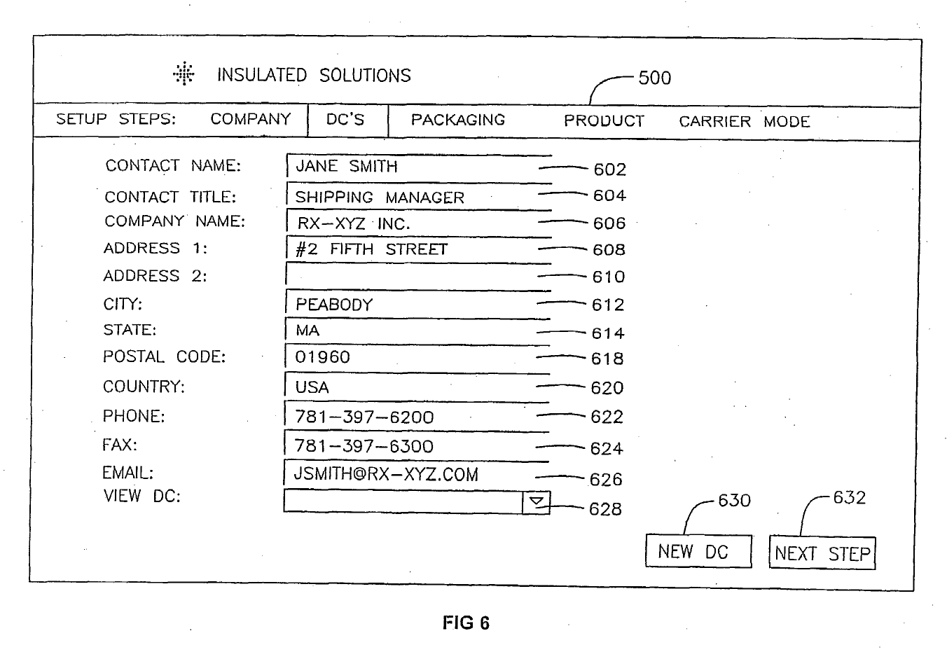

FIG. 6 illustrates a DC's (distribution centers) entry screen for the setup phase. The display contains a contact name box 602, contact title box 604, company name box 606, address “1” box 608, address “2” box 610, city box 612, state box 614, postal code box 616, country box 620, phone number box 622, fax number box 624, e-mail box 626, and a distribution center pull down selection box 628. Button 630 is provided for new DC, and another button 632 to move onto the next step.

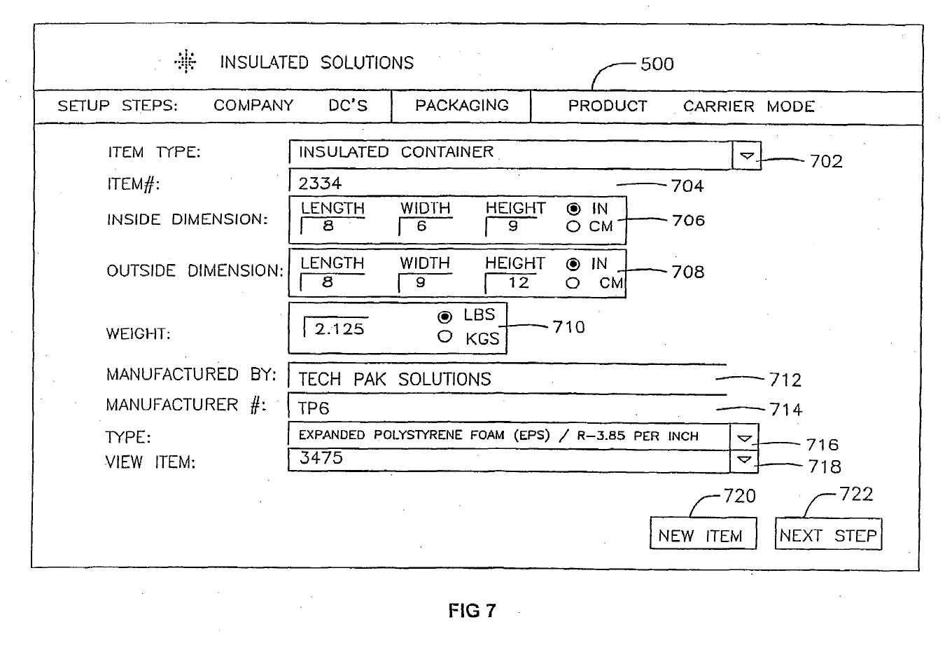

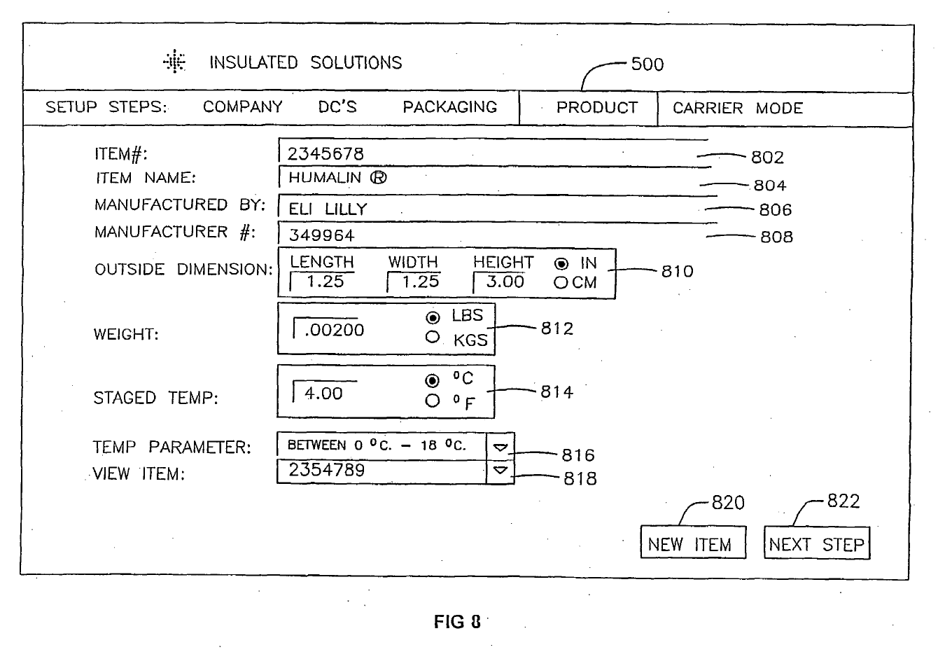

FIG. 7 illustrates a packaging entry screen for the setup phase. The screen has a pull down selection box 702 for the item type, a box 704 for the item #, inside dimension box 706, outside dimension box 708, weight box 710, manufacturer by box 712, manufacture# box 714, a pull down selection box 716 for type, and pull down selection box 718 for view item. Two buttons are provided, a first button 720 for new item, and a second button 722 for the next step 722. FIG. 8 illustrates a product entry screen during the setup phase. The screen has a box 802 to enter the item#, item name box 804, manufactured by box 806, manufacture# box 808, outside dimensions box 810, weight box 812, staging temperature box 814 and pull down selection box 816 for the temperature parameters, and view item box 818. Two buttons are provided; the first button 820 is for a new item and a second button 822 for the next step.

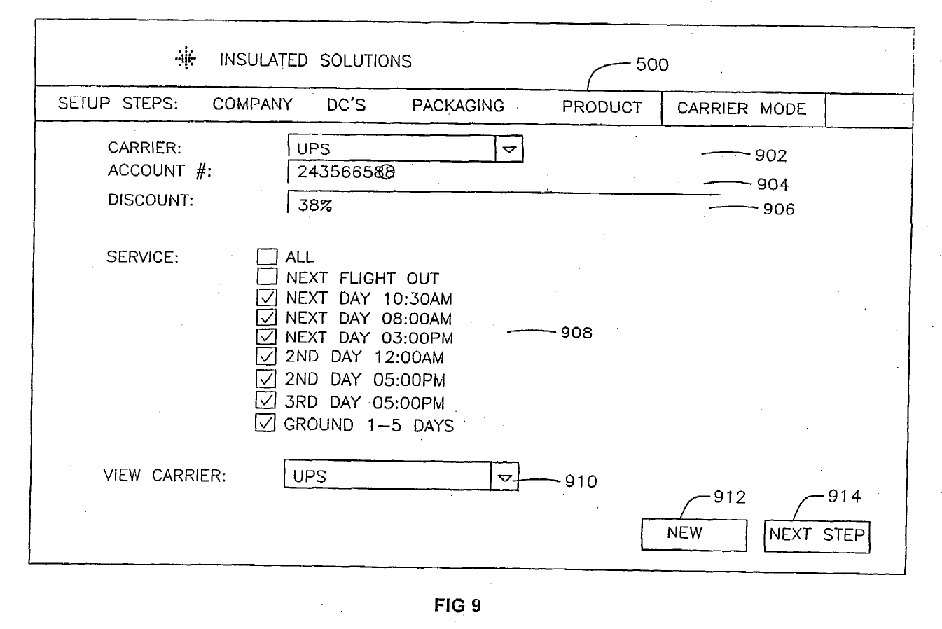

FIG. 9 illustrate a carrier/mode entry screen for the setup phase, located on the top of the screen is a menu 500. A pull down selection box 902 is provided for entering the carriers that the shipper employs. There are also boxes for the account# box 904, discounts box 906, boxes 908 to select the service or mode that the carrier offers, and pull down selection box 910 for selecting the carrier to view. Two buttons are also provided, the first button 912 for new carrier and the second button 914 is next step.

In one embodiment of the present invention, as illustrated in FIG. 2, returning to the optimization process after the necessary information has been entered into system 10 and stored in database 114, system 10, queries product database 148 to determine the safety buffer required for each delivery option, at step 206. As discussed above, the safety buffer refers to the thermal range in addition to the temperature parameters provided that will ensure safe delivery of the package, particularly in the case of extremely temperature sensitive products.

Next at step 208, using carrier/mode database 152, carrier/mode routing engine 112 determines the total time, including the safety buffer, that each delivery option requires. At step 210, querying product database 148 and packaging database 150, optimization engine 108 determines all of the possible packaging container options for the product. For each viable packaging container option, the outside dimension, inside dimension, weight, cost, and thermal properties (R-value, insulation thickness, etc.) are obtained.

Next at step 212, system 10 creates a “packaging system” for each viable package option. Each packaging system includes the container (fixed), the product shipped (fixed), and the refrigerant/warm pack quantity (variable).

Querying the product database, at step 214, system 10 determines the ambient temperature for each packaging system during its route. In step 216, ambient thermal temperature modeling engine 110 generates an ambient thermal temperature profile 1100, as illustrated in FIG. 11 based on predetermined information (static), based on historical temperatures by querying weather database (historical) 146a, or based on actual real-time forecasted weather data by querying the weather database (forecasted) 146b.

In step 218, packaging thermal modeling engine 106 calculates the amount of refrigerant/warm packs necessary for the packaging system to stay within the required temperature parameters as determined in product database 148 for the previously calculated required time period, for the shipping route.

At step 220, knowing the refrigerant/warm pack quantity necessary to maintain the product within its temperature parameters for each packaging system, system 10 stores each result in memory as a feasible shipping solution.

In step 222, by querying the packaging database 150 the optimization engine eliminates all possible shipping solutions that require more refrigerant/warm packs than the insulated container can contain by volume. In step 224, carrier/mode costing engine 104 determines the shipping cost for each possible shipping solution that has not been eliminated.

At step 226, system 10 queries packaging database 150 and determines the total cost of each feasible shipping solution by adding the total packaging cost for each possible shipping solution to the shipping cost determined above. In step 228, optimization engine 108 then presents the user at selection module 116 with all the possible shipping solutions sorted by total cost, or total cost by specified delivery date or any other useful method of organization on which the shipper may base their shipping decision. (FIG. 10 illustrates the screen 1000 for shipping solutions 1010 selection. As illustrated, selection options 1010 include the expected delivery date, carrier and cost, however, this is in no way intended to limit the scope of the present invention. For example, additional criteria that may be displayed on screen 1000 in solutions 1010 include but are not limited to, shipping weight, packaging type/material, insurance cost, refrigerant/heat amount and cost) An step 230, the user (order-entry) selects a possible shipping solution.

That selected shipment solution is stored in shipment solution database 118, at step 232. As discussed above shipment solution database 118 may use a preselected solution or an actively chosen solution. Next at step 234, a pick list is generated from the shipment solution database 118 when the user (pick/pack) selects to pack an order. This includes the selection of the appropriate container with its insulating packing material, including the amount of refrigerant warm pack needed.

At step 236, user (pick/pack) module 120 completes the pick/pack function and places the package on scale 130 of shipment workstation 126. At step 238, the user (pick/pack) 120 enters or scans the order number into shipment workstation 126. At step 240, shipment solution database 118 sends shipment information to shipment workstation 126.

At step 242, quality control check module 124 verifies the weight of the complete package and determines if the weight matches the weight stored in shipment solution database 18. In step 244, shipment workstation 126 prints the appropriate label from label printer 128 for the completed order and stores the order's tracking number in tracking and tracing database 134.

Next at step 246, the product database 148 is queried to determine the products environmental and data monitor parameters. In step 248 the wireless security key database 154 is queried to obtain the necessary security keys the wireless data monitor 122 will need to log onto secure wireless access points 162 and secure mobile wireless communication devices 168 along its shipping route. In step 250 wireless access point 132 sends a signal to the wireless data monitor 122 to begin monitoring and recording the environmental conditions and unique wireless access points and associated signal strength in its vicinity.

In step 252, as discussed above, any environmental conditions that are recorded beyond a tolerance range will trigger an out of range alarm indicator on the wireless data monitor 122 and send an alert notification on its next transmission.

In step 254 wireless data monitor 122 determines if the wireless access points or mobile wireless communication devices in its vicinity require secure authentication to log onto. If so it determines if it has the necessary security keys 122e and proceeds to log on.

In step 256, the wireless data monitor 122 logs onto a wireless access point 162/164 or a wireless mobile communication device 168 and transmits to the tracking and tracing database 134 via the internet 166 the environmental conditions, alarm status, and unique wireless access points and their associated signal strength recorded along the shipment route. The wireless data monitor 122 receives confirmation that the data sent above has been received. If no confirmation is received the wireless data monitor 122 will continue to attempt to resend the recorded data.

In step 260 the wireless data monitor 122 repeats steps 250-258 until the shipment is delivered to its recipient.

In step 262, the recipient of the package determines if the product has traveled safely within its environmental parameters.

At step 264, by querying database 114 of system 10 reporting engine 142 evaluates and audits system's 10 performance and reliability and fine tunes system 10 for maximum efficiency.

The invention delivers numerous advantages to clients. The system removes guesswork when shipping perishables. It reduces product spoilage, improve customer satisfaction, and reduce inventory and distribution costs. It helps shippers comply with existing government and carrier regulations and offer clients means to enhance growth with an opportunity to expanding into new markets and subsequent sales opportunities. The invention enables a company to better utilize its internal resources—thus reducing the time and energy required to manage their transportation operations. The invention is a systematic approach for creating, implementing, managing, and monitoring a transportation master strategy.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for monitoring environmental conditions within a shipping package said method comprising the steps of:
generating a package shipment route;
entering an environmental parameter corresponding to an exposure level beyond which a product, contained in said package, will perish;
inserting a wireless data monitor within said package, configured to monitor the environmental condition within said package along said shipment route;
during shipment, collecting said environmental data at said wireless data monitor; and
during shipment, periodically transmitting said collected environmental data to one or more wireless access points.

2. The method as claimed in claim 1, wherein said wireless data monitor operates using IEEE standard 802.11(x).

3. The method as claimed in claim 1, wherein said environmental data is monitored periodically through the duration of shipment.

4. The method as claimed in claim 1, wherein said transmission of said collected environmental data is done periodically to a plurality of wireless access points located along said shipment route.

5. The method as claims in claim 1, wherein said transmission of said collected environmental data by said wireless data monitor to said wireless access point is triggered when said wireless data monitor connects with a wireless access point having a recognizable unique identifier or portion of a unique identifier.

6. The method as claimed in claim 4, wherein at least one of said wireless access points is a hand held device of a delivery person at the point of delivery of said package.

7. The method as claimed in claim 6 wherein said package is associated with a tracking number that indicates that a wireless data monitor is contained therein.

8. The method as claimed in claim 7, wherein when said hand held device reads said tracking number of said package, said hand held device alters or changes its wireless access point unique identifier in manner that is recognizable by said wireless data monitor, triggering said wireless data monitor to send said collected environmental data to said hand held device.

9. The method as claimed in claim 8, wherein said hand held device receives said environmental data in an ad hoc protocol.

10. The method as claimed in claim 4, wherein an alarm is registered if the environmental condition within said package exceeds said environmental parameters during travel along said shipment route.

11. The method as claimed in claim 8, wherein an alarm is registered with said hand held device at delivery of said package if the environmental conditions within said package exceed said environmental parameters during travel along said shipment route.

12. The method as claimed in claim 4, wherein said wireless data monitor tracks unique identifiers for said wireless access points located along said shipment route.

13. The method as claimed in claim 9, wherein said unique identifiers of said wireless access points are associated with a location data obtained using a location identification technology employed by said wireless data monitor.

14. The method as claimed in claim 6, wherein said hand held device tracks unique identifiers for said wireless access points located along said shipment route.

15. The method as claimed in claim 1, wherein said step of generating a package shipment route further includes a step of generating a listing of all possible shipment routes available for said package between a place of origin and a destination; and for each of said shipment routes, generating an ambient thermal temperature model corresponding to the external temperatures of said package, including said product information, insulation in said package, and refrigeration or heating used in said package, and analyzing said thermal characteristics along said available shipping routes, based on each of said ambient thermal temperature models, so as to determine feasible shipment routes and corresponding packaging information, sufficient to prevent said product from perishing by preventing the environmental conditions of said product from diverting from said environmental parameter.

16. The method as claimed in claim 15, wherein said ambient thermal temperature models utilize historical environmental data from said collected environmental data from said wireless data monitor.

17. The method as claimed in claim 15, wherein for each of said feasible shipment routes, calculating the cost for shipment along said feasible shipment routes based on packaging and delivery cost; selecting a route for delivery from among said feasible shipment routes, and presenting said selected route to a user so as to allow said user to ship said product via said selected route.

18. A method for monitoring environmental conditions within a shipping package said method comprising the steps of:
generating a package shipment route;
entering an environmental parameter corresponding to an exposure level beyond which a product, contained in said package, will perish;
wherein said step of generating a package shipment route further includes a step of generating a listing of all possible shipment routes available for said package between a place of origin and a destination; and
for each of said shipment routes, generating an ambient thermal temperature model corresponding to the external temperatures of said package, including said product information, insulation in said package, and refrigeration or heating used in said package, and analyzing said thermal characteristics along said available shipping routes, based on each of said ambient thermal temperature models, so as to determine feasible shipment routes and corresponding packaging information, sufficient to prevent said product from perishing by preventing the environmental conditions of said product from diverting from said environmental parameter;
inserting a wireless data monitor within said package, configured to monitor the environmental parameters within said package along said shipment route;
wherein for each of said feasible shipment routes, calculating the cost for shipment along said feasible shipment routes based on packaging and delivery cost; selecting a route for delivery from among said feasible shipment routes, and presenting said selected route to a user so as to allow said user to ship said product via said selected route;
during shipment, said wireless data monitor collecting environmental data; and
during shipment, periodically transmitting said collected environmental data to one or more wireless access points.

19. The method as claimed in claim 18, wherein said wireless data monitor operates on IEEE standard 802.11(x).

20. The method as claimed in claim 18, wherein said transmission of said collected environmental data is done periodically to a plurality of wire access points located along said shipment route.

21. The method as claimed in claim 20, wherein at least one of said wireless access points is a hand held device of a delivery person at the point of delivery of said package.

22. The method as claimed in claim 20, wherein an alarm is registered if the environmental conditions within said package exceed said environmental parameters during travel along said shipment route.

23. The method as claimed in claim 21, wherein an alarm is registered with said hand held device at delivery of said package if the environmental conditions within said package exceed said environmental parameters during travel along said shipment route.

24. A method for monitoring environmental conditions within a shipping package said method comprising the steps of:
generating a package shipment route;
entering an environmental parameter corresponding to an exposure level beyond which a product, contained in said package, will perish;
inserting a wireless data monitor within said package, configured to monitor the environmental conditions within said package along said shipment route;
during shipment, said wireless data monitor collecting environmental data; and
during shipment, periodically transmitting said collected environmental data to one or more wireless access points, wherein if a connection is made to a wireless access point the unique identifier of said wireless access points are recorded along with the geographic location of said wireless access points.

25. The method as claimed in claim 24, further comprising the step of supplementing said data of said unique identifier of said wireless access points and geographic location of said wireless access points with additional unique identifiers and geographic locations of said wireless access points collected by hand held devices of a delivery person along said shipment route.
